(19) United States
(12) Patent Application Publication
(10) Pub. No.: US 2003/0158657 A1
(43) Pub. Date: Aug. 21, 2003

(54) Navigation system

(76) Inventors: Hugh John Agnew, Hampshire (GB); Roger Wooley, Hampshire (GB); Vincent Geake, Hampshire (GB)

Correspondence Address: FINNEGAN, HENDERSON, FARABOW, GARRETT & DUNNER, LLP, 1300 I STREET, NW, WASHINGTON, DC, 20005, US

(21) Appl. No.: 10/239,501

(22) PCT Filed: Mar. 23, 2001
(86) PCT No.: PCT/GB01/01289

(30) Foreign Application Priority Data
Mar. 23, 2000 (GB) 0007105.0

(51) Int. Cl. G01C 21/30

(52) U.S. Cl. 701/208; 701/213

(57) ABSTRACT

A navigation guidance system is provided which provides direction information form a remote server to a mobile user unit for guiding the user to a desired destination. The user unit may be a mobile telephone or PDA or the like. A query is input to the user unit either by text or by voice and is sent to the remote server. The mobile unit preferably includes a GPS receiver or the like so that the current location of the mobile telephone can also be transmitted to the remote server. Based on the information received from the user unit, the server determines the appropriate route guidance information and sends this back to the user unit. In a preferred form of the invention, the remote server continues to monitor the progress of the user unit in following the route guidance information and, where appropriate, sends updated route guidance information.

The present invention relates to a system and method for providing navigation assistance and tracking information from a server to a user unit. The invention is particularly, although not exclusively relevant to a system for providing a mobile unit, such as a telephone, with route guidance information which is calculated at a fixed server in response to a query from the mobile unit.

Systems have been proposed which provide geographical or position dependent information to a mobile user. Such systems are generally installed in the user's vehicle and include an on-board geographic database which is accessed to determine the required geographic information, such as locations of points of interest, directions to points of interest and directions between a specified origin and a specified destination. The on-board computer includes a positioning calculation system, such as a GPS system, from which it can determine the vehicle's current position. It then uses this current position information together with the stored geographic information and the query to generate the appropriate navigation information which is output to the user either audibly or on an appropriate graphical display. The systems proposed to date are normally self-contained. In other words, all the geographic information is stored in the vehicle. The system therefore suffers from the problem that the database stored in the vehicle will soon become out of date as changes occur to the geographic landscape.

Therefore, in order to update the system, new databases must be installed in the vehicle from time to time. This is time consuming and costly to the service providers.

U.S. Pat. No. 5,543,789 discloses a system for providing route guidance information from a central base unit to a mobile unit in response to a query received from the mobile unit. However, the system proposed in this patent may not be appropriate for all user queries.

An aim of the present invention is to provide an alternative navigation system which is more user friendly.

According to one aspect, the present invention provides a navigation system comprising a mobile user unit and a remote server, the user unit comprising (i) means for transmitting navigation requests to the remote server; (ii) means for receiving navigation guidance information from the remote server; and (iii) means for outputting the received navigation guidance information to the user; and the remote server comprising: (i) means for receiving navigation guidance requests from the user unit and location information of a current location of the user unit; (ii) means for determining navigation guidance information in response to the received request and the current location of the user; and (iii) means for transmitting the determined navigation guidance information to the user unit. The remote server preferably continues to monitor the location of the user unit as it travels to a requested destination and, if appropriate, transmits updated guidance information to the user.

In a preferred mode of operation, the remote server determines a plurality of way points between the user's current position and the required destination and is operable to transmit navigation guidance information to guide the user from his current location to a current way point and then to transmit updated navigation guidance information for guiding the user to the next way point when the user approaches the current way point. In this way, the user can be guided with relatively simple instructions to travel from a current position to a required destination.

The user unit may be a telephone which meets the WAP (wireless applications protocol) description which includes a limited display and limited processing power. The navigation information downloaded from the remote server may include thumbnail sketches of routes to be taken, text messages or voice navigation instructions, or any combination of these.

The remote server preferably includes an object orientated geographic information system which allows the creation of avatars within the database, each of which is operable to resolve a query from a respective user.

Embodiments of the present invention will now be described with reference to the accompanying drawings in which:

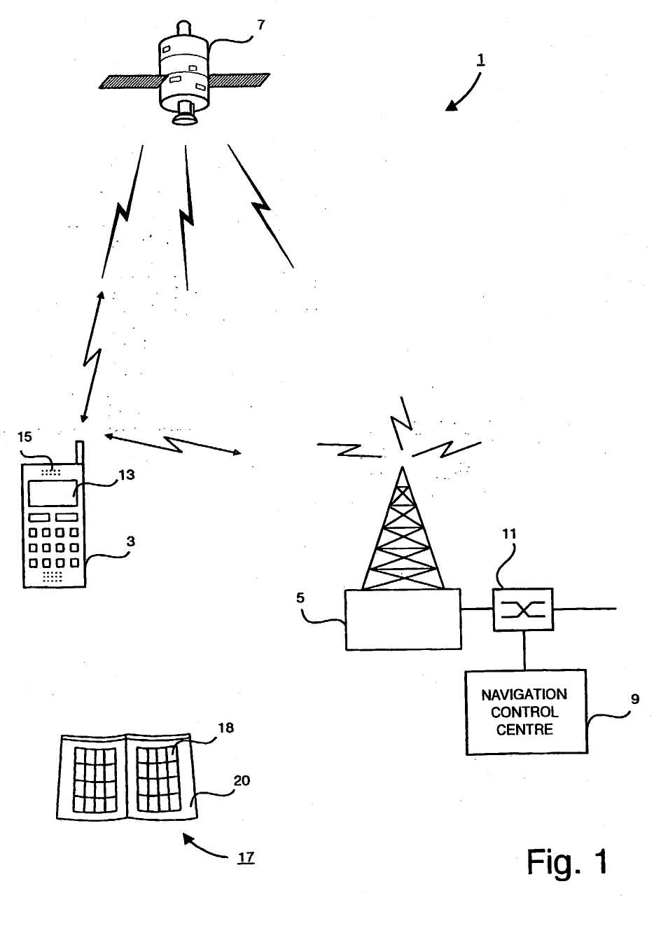

FIG. 1 is a schematic diagram illustrating a navigation system embodying the present invention;

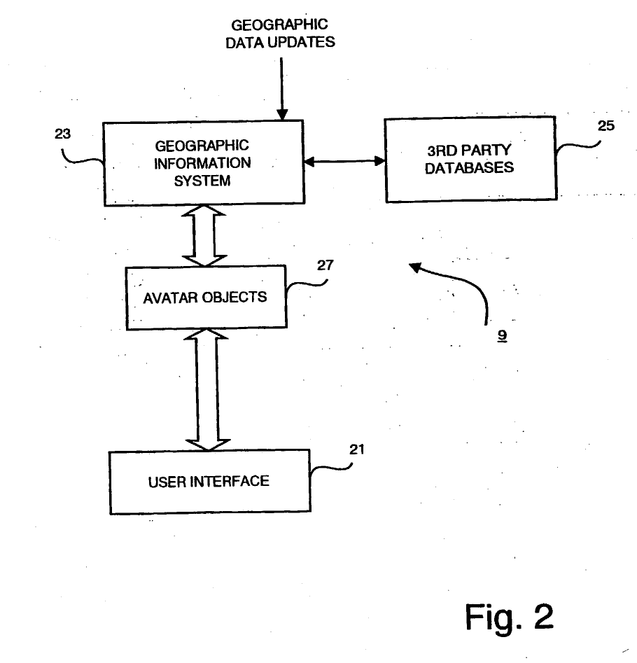

FIG. 2 is a schematic block diagram illustrating the main components of a navigation control centre which forms part of the system shown in FIG. 1;

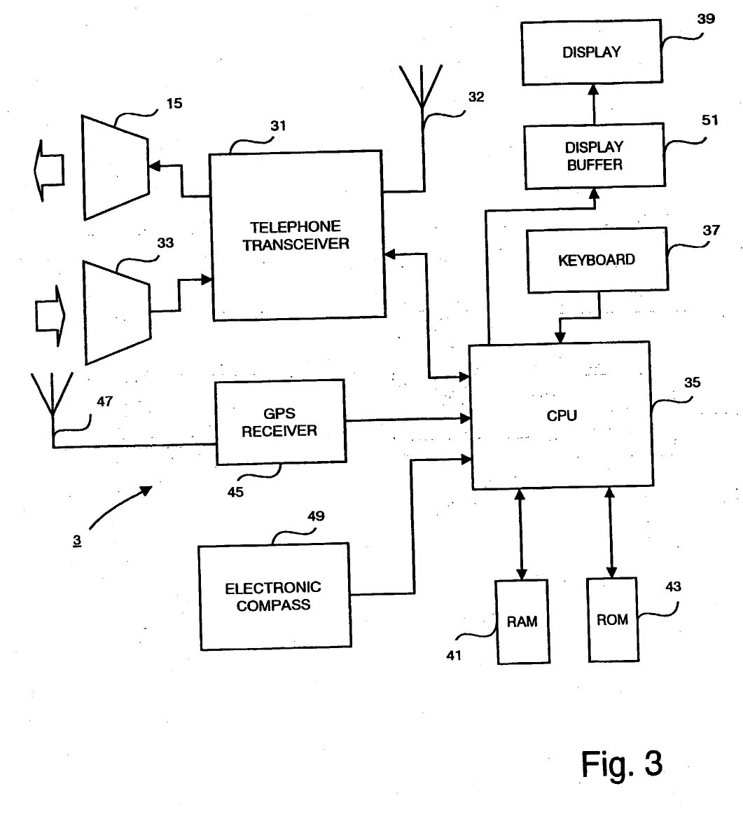

FIG. 3 is a schematic block diagram of a mobile telephone which forms part of the navigation system shown in FIG. 1;

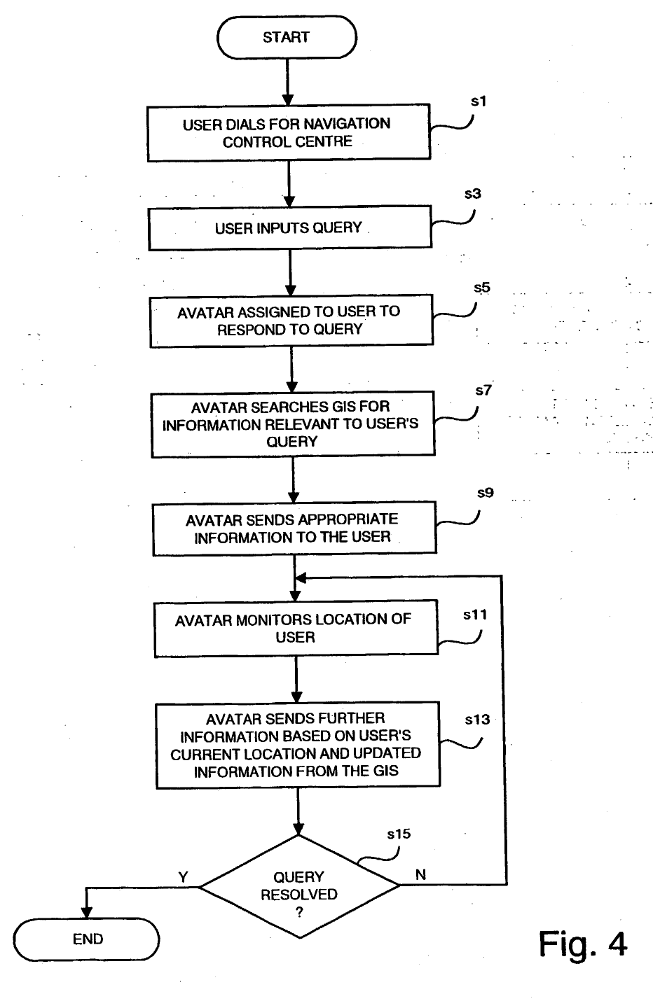

FIG. 4 is a flowchart illustrating the main steps involved in a query made by a user using the mobile telephone and the steps taken by the navigation control centre in response to that query;

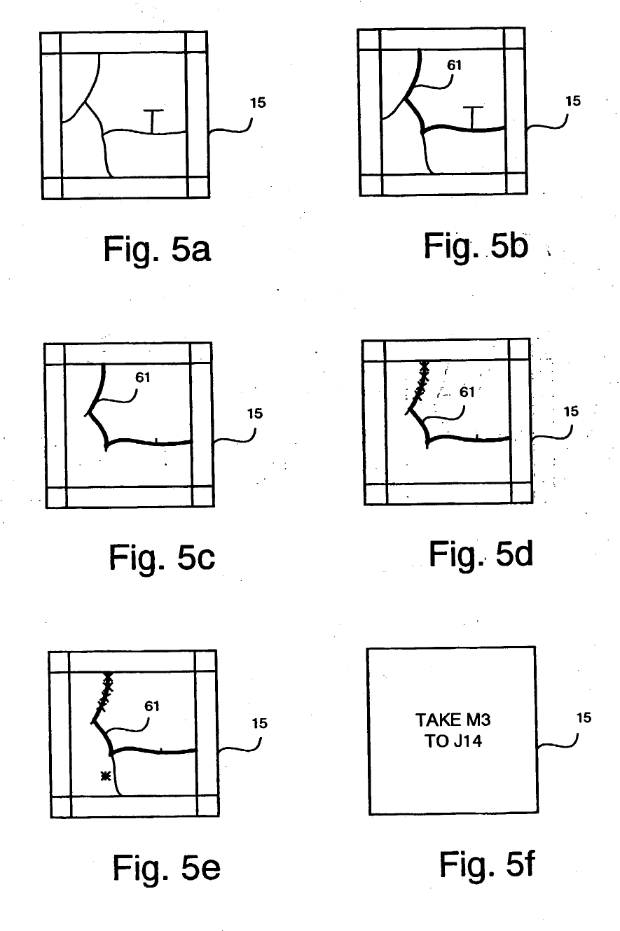

FIG. 5a schematically illustrates map data which is displayed on the display of the mobile telephone in response to the user's input query;

FIG. 5b illustrates the map data displayed in FIG. 5a overlaid with a route to be followed;

FIG. 5c illustrates the map data shown in FIG. 5b with unnecessary roads truncated;

FIG. 5d schematically illustrates the map data shown in

FIG. 5c with a snail trail overlaid indicating the route taken by the user;

FIG. 5e schematically illustrates the map data shown in FIG. 5d with a specified point of interest shown together with necessary roads to arrive at the point of interest;

FIG. 5f is a schematic diagram of a textual display illustrating routing instructions which are received by the mobile unit in response to a user's query; and

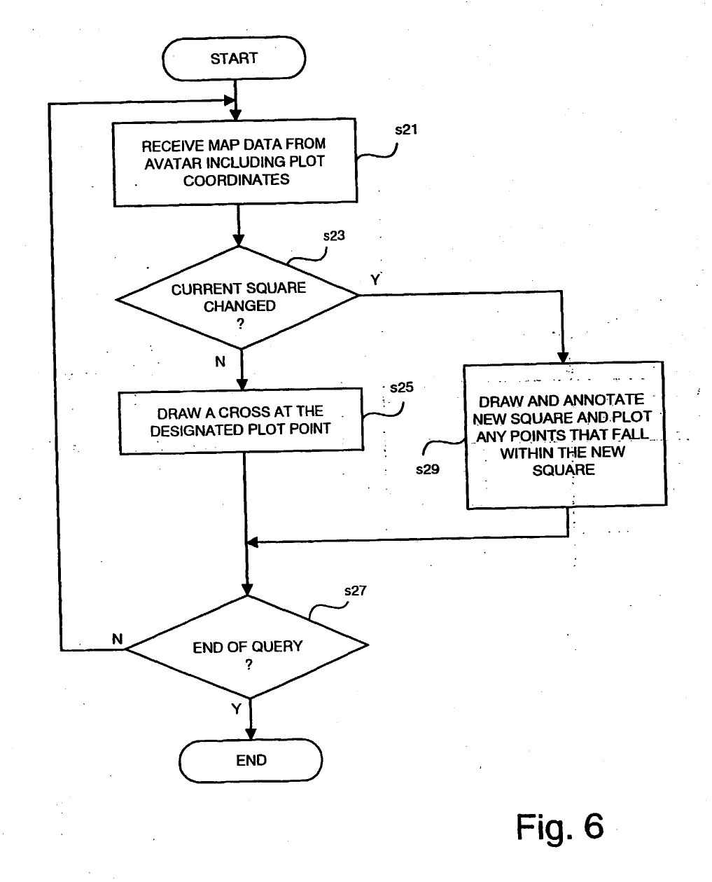

FIG. 6 is a flowchart illustrating an updating procedure employed by the mobile telephone in response to updated routing data received from the navigation control centre.

FIG. 1 is a schematic representation of a navigation system 1 embodying the present invention. The system 1 includes a mobile telephone 3 which is operable to communicate with a mobile base station 5 of a cellular telephony system (not shown) in the usual way. In this embodiment, the mobile telephone 3 includes a GPS receiver (not shown) which receives positioning signals from overhead satellites 7. The mobile telephone 3 can therefore determine its current location on the earth's surface from the signals received from the GPS satellites 7. The navigation system 1 also includes a navigation control centre 9 which the user can access by placing an appropriate call via the base station 5 and the telephone switching network 11.

The navigation control centre 9 is operable to receive navigation queries from a number of users having a mobile telephone 3 (or similar communication device) and to provide navigation instructions back to the user by retrieving data from a geographic information system (GIS) which forms part of the control centre 9. The type of query that the navigation control centre 9 can respond to include queries such as:

where am I?

where is the nearest service station, restaurant etc?

how do I get to Lymington, Oxford, the nearest service station etc?

The positioning or navigation information transmitted back from the navigation control centre 9 to the mobile telephone 3 may include graphical data, text data and/or voice data, which can be output to the user on the display 13 or through the speaker 15 where appropriate. In this embodiment, the mobile telephone user also has a specific atlas 17 (such as the Geographers' A-Z Master Atlas of Greater London Edition 4B) and this information is transmitted to the navigation control centre 9 together with the query, so that the information which is transmitted back to the mobile telephone includes navigation data specific for the atlas. For example, this may include grid numbers of specific grids 18 on specific pages 20 of the atlas as well as a graphical “thumbnail” sketch of the or each identified grid of the atlas together with main roads etc illustrating the route to be taken or the location of a point of interest.

A brief outline has been given above of the navigation system embodying the present invention. A more detailed description will now be given of the principal components of the navigation control centre 9 and of the mobile telephone 3 followed by a more detailed operational description of the navigation system.

Navigation Control Centre

FIG. 2 is a schematic block diagram illustrating the main components of the navigation control centre 9. As shown, it comprises a user interface 21 which is connected to the telephone switching network 11 (shown in FIG. 1) and which is operable to receive the user queries and to transmit navigation information back to the user. The control centre 9 also includes a geographic information system (GIS) 23 which stores data relating to various geographically located features, such as locations of service stations, restaurants, cinemas etc. The GIS 23 also stores data relating to various maps and atlases as well as details of current major roadworks and other travel information. As shown in FIG. 2, the data in the GIS 23 can be updated on a real time basis so that the most accurate and reliable geographic information is available to the users at all times. The geographic information system 23 may also access third party databases where it is more appropriate to use third party databases rather than to store the data centrally in the GIS 23. This could be the case where the data stored in the third party database changes frequently and is not accessed regularly by the users. The third party database may be, for example, a database detailing the locations and current operational status of automated teller machines (ATMS) of a particular Bank.

In this embodiment, in order to interact with the GIS 23, when a user inputs a query, an avatar 27 is assigned to the user which is aware of the user's interests and request and operates to interrogate the database to obtain the information which is required and then to transmit the data back to the user via the user interface 21. As those skilled in the art will appreciate, the use of a dedicated avatar for each user provides a more useful service than a simple interactive information provider. For example, rather than simply asking the GIS when the next bus is due at a particular bus stop, the avatar can be instructed to keep a watch on the bus and to notify the user of the actual time when the bus is approaching the bus stop.

In response to a navigation request, the avatar 27 receives the user's current position (which, in this embodiment, is transmitted from the mobile telephone 3 through the telephone switching network 11 and the user interface 21) and the desired destination, then plans the best route referring to maps and other geographic data stored in the GIS to work out directions to send to the user so that the user can find the destination.

Mobile Telephone

FIG. 3 is a block diagram, illustrating the main components of the mobile telephone 3 shown in FIG. 1. As shown, the mobile telephone 3 includes a telephone transceiver 31 which is operable to receive voice data from the base station 5 and to transmit voice data to the base station 5 through the communications aerial 32. The voice data received from the base station 5 is decoded by the telephone transceiver 31 and output to the speaker 15. Similarly, the speech signal of the user is converted by the microphone 33 into a corresponding electrical signal which is encoded into voice data by the telephone transceiver 31 and transmitted to the base station 5 via the aerial 4.

The mobile telephone 3 also includes a central processing unit (CPU) 35, keyboard 37 and a display 39. The keyboard 37 allows the user to enter the number of the party to be called as well as any text query to be sent to the navigation control centre 9. As with a conventional telephone, during a dial-up operation, the number being entered by the user is displayed on the display for verification purposes. Once the user has confirmed the number to be dialled, the CPU 35 passes the appropriate signalling information to the telephone transceiver 31 for transmission to the base station 5, for setting up the appropriate call connection. The mobile telephone 3 also includes a RAM 41 which provides a working memory for the telephone as well as a ROM 43 which stores user telephone numbers and control software for controlling the operation of the telephone 3.

As shown in FIG. 3, in this embodiment, the mobile telephone 3 also includes a GPS receiver 45 which is operable to receive GPS satellite signals through the GPS aerial 47 (which, in this embodiment, is separate from the communication aerial 32) and to determine the current location of the mobile telephone 3 on the earth's surface. This information is passed to the CPU 35 which stores the position information in the RAM 41. In this embodiment, the GPS receiver is operable to update the current location several times per second. The mobile telephone 3 also includes an electronic compass 49 which is operable to determine the current orientation of the mobile telephone 3 relative to some reference bearing, such as north. The orientation information determined by the electronic compass 49 is also passed to the CPU 35 which stores this information in the RAM 41.

In this embodiment, the display 39 is a graphical display so that it can display the graphical navigation information received from the navigation control centre 9. Therefore, in this embodiment, a display buffer 51 is provided which stores the bit map for the current display as set by the CPU 35.

Exemplary Operation

The way in which the navigation control centre 9 and the mobile telephone 3 operate in this embodiment will now be described in more detail with reference to FIGS. 4 to 6. FIG. 4 shows a flow chart of the processing steps involved in a navigation query. Initially, in step s1, the user dials the appropriate number to connect to the navigation control centre 9, via the base station 5 and the telephone switching circuit 11. This creates a communication channel between the mobile telephone 3 and the navigation control centre 9. The user then inputs, in step s3, the navigation query (which may be a voice query or a text query). This navigation query is then transmitted to the user interface 21 of the navigation control centre 9 together with current position and orientation information stored in the RAM 41 of the mobile telephone 3. If available, the mobile telephone 3 also transmits details of any maps or atlases that the user has. This information may form part of the user's input query or may be pre-stored in the RAM 41.

In this embodiment, if the user's input query is a voice query, then it is processed and converted into a text query by a speech recognition system (not shown) located in the user interface 21 of the navigation control centre 9.

After the user's query has been received, the navigation control centre 9 assigns, in step s5, an avatar 27 to the user for responding to the user's query. As shown, in step s7, the avatar searches the GIS 23 for information relevant to the user's query. Initially, this involves the avatar converting the latitude/longitude signal from the GPS receiver into either metres or seconds of arc depending on the layout of the selected atlas. The avatar 27 then searches all maps in the selected atlas to determine upon which maps the current position of the mobile telephone lies. For each of the maps found, the avatar then determines the position of the square vertices containing the current location both in terms of grid coordinates and geographic coordinates. The avatar 27 also determines the position of the current location of the telephone 3 relative to the bottom left vertex of the square, for plotting purposes. The avatar 27 then encodes the atlas name, map, column and row address and plot details for the current location of the mobile telephone and then transmits this information back, in step s9, to the user's mobile telephone 3. In response, the mobile telephone 3 decodes the map data received from the navigation control centre 9 and displays the data on the display 39 and outputs, if appropriate, text data on the display 39 as well, or voice data through the speaker 15. If appropriate, the avatar 27 also sends instructions to the user, based on the received orientation information, to ensure that the user starts off in the right direction. For example, having determined that the user must travel north up a predetermined street, the avatar may send information to the user to instruct him to hold the phone in front of him with the display facing the user. The avatar may then interrogate the CPU to determine the mobile telephone's current orientation (which is determined from the electronic compass 49) and uses this information to instruct the user to proceed in the correct direction.

In some embodiments, the processing will end after step s9. However, in this embodiment, as shown in step s11, the avatar continues to monitor the location of the user by means of covert communications with the mobile telephone 3 (i.e. without ringing the mobile) during which the current location of the telephone (which is stored in RAM 41) is transmitted to the navigation control centre 9. Based on the progress of the user in travelling, for example, to a required destination, or in response to updated travel information in the GIS 23, the avatar sends, in step s13, further information to the user. In this embodiment, the avatar does this by determining if the current location of the mobile telephone 3 is still within the same square of the map. If it is, then it simply sends data corresponding to the new position of the user within the map for display on the display 39 of the mobile telephone 3. If however the user has moved to an adjacent square, then the avatar redraws the new square and sends new map data to the mobile telephone 3. In order to transmit the updated information to the user, the avatar initiates a telephone call through the telephone switching centre 11 and the base station 5 to the mobile telephone 3. In this case, the call is not covert and the mobile telephone will ring alerting the user of the incoming call. Upon answering the call, the updated information is downloaded to the mobile telephone 3.

As shown in FIG. 4, as a result of the query step s15, in this embodiment, steps s11 and s13 are repeated until the user's input query has been resolved. In other words, if the user has requested directions to the nearest service station, then the navigation control centre 9 will continue to monitor the location of the user until the avatar confirms that the user has arrived at the service station or until it receives a query cancellation instruction from the user. By allowing the avatar to continuously monitor the user's progress, the system can be made more user friendly since the avatar does not need to provide the user with detailed instructions in response to the initial input query. Instead, the avatar can provide the user with step by step instructions to arrive at a required destination, giving the user the next set of instructions once the user has arrived at some determined way point.

As mentioned above, the navigation information can be provided in various different ways, either audibly or visually. The best combination depends on the technology available to the user in the mobile telephone 3, the data network that connects the user to the navigation control centre 9 and the environment in which the user is located. Where the mobile telephone 3 can display limited graphics, then the information may be provided as “thumbnail” sketches showing a particular map area identified within an atlas the user has in his possession. The thumbnail sketch will only show the necessary information to help the user identify the information on the paper map. The thumbnail sketch may comprise several layers including:

local major road network

local minor road network

selected route

“snail trail” showing recent position history of the user

locations of points of interests (e.g. specific brand petrol stations, ATMS, speed cameras etc)

specific “destination” entities (e.g. named hotel, target delivery address etc)

specific “interest” entities (e.g. tourist information etc).

As those skilled in the art will appreciate, the information should not be displayed if it is not relevant at the current time. For example, if the user is following a route displayed overlaid on the major and minor road networks, the minor road network may be truncated or suppressed where it does not immediately adjoin the route (i.e. to form a “stick map”). In addition to these graphic displays, information can also be delivered as text messages or voice messages, which inform the user of road signs to follow, distances to go, the map page(s) number and grid(s) number corresponding to the displayed information etc.

FIGS. 5a to 5e schematically illustrate different forms of “thumbnail” sketches which may be shown. In particular, FIG. 5a shows the map data for a grid 19 from a page 20 of the atlas the user has, which identifies the major and minor road networks in the block. FIG. 5b shows the map data shown in FIG. 5a together with the route to be followed 61 shown in bold. FIG. 5c shows the map data shown in FIG. 5b with the unnecessary roads truncated. FIG. 5d shows the map data shown in FIG. 5c with a snail trail overlaid indicating the route that has been taken by the user and the user's current position along the route 61. FIG. 5e shows the map data shown in FIG. 5d with a specified point of interest, such as a specific brand petrol station, together with the necessary road to arrive at the point of interest. Finally, FIG. 5f illustrates a text message illustrating an initial instruction issued by an avatar in response to a user query requesting directions for travelling from London to Lymington in Hampshire. In this case, when the user has taken the M3 and is approaching junction 14, the avatar will call up the user's mobile telephone 3 and provide the next set of instructions to direct the user towards Lymington.

FIG. 6 illustrates a flow chart of the processing steps performed by the CPU 35 of the mobile telephone 3 in response to receipt of the navigation data from the navigation control centre 9. As shown, in step s21, the CPU 35 receives the map data from the avatar which includes the identification of a plot point detailing the mobile telephone's current position along the selected route. The processing then proceeds to step s23, where the CPU 35 determines whether or not the received map data corresponds to a new square of the atlas. If it does not, then the processing proceeds to step s25 where the bit map for the current display (which is stored in the display buffer) is updated by adding a cross at the designated plot point. The processing then proceeds to step s27 where the CPU 35 determines whether or not the current query is still valid—either because the user has not reached the requested destination or has cancelled the requested navigation assistance. If the query is still being processed, then the processing returns to step s21 where the CPU 35 awaits the next set of map data and plot point from the avatar in the navigation control centre 9. If at step s23, the CPU 35 determines that the current map data identifies a new square of the atlas, then the processing proceeds to step s29 where the CPU draws and annotates the new square into the display buffer 51 and plots any points of the snail trail which are also located in the new square. The processing then returns to step s27 as before. Once the user's query has been dealt with or has been cancelled, the processing ends.

In this embodiment, the type of update information (i.e. graphic, text or voice) transmitted to the mobile telephone 3 is dependent upon the user's current location relative to the route planned by the avatar 27. In particular, if the user is travelling along the route planned by the avatar 27, then the avatar will continue to update the map data as discussed above. However, if the user wanders off the planned route, then the avatar 27 will detect this and will send an appropriate warning message, which may be text or voice. The avatar 27 will then provide further information for the user to allow him to decide whether to return to the original route or to request the system to calculate a new route which cancels the previous navigation request. In this way, the system is more robust, not only to errors in following the planned route made by the user, but also to errors in planning the route made by the avatar because the GIS is not up to date.

Modifications and Alternatives

A description has been given above of a navigation system employing a mobile telephone and a fixed navigation control centre. Rather than being part of a mobile telephone, the navigation system may form part of a hand held personal digital assistant (PDA), web browser, laptop PC or the like.

In the above embodiment, a geographic information system was provided storing large amounts of geographic information and an avatar was assigned to each user to service that user's query. The avatar does this by filtering the information stored in the GIS to extract the necessary subset of geographic information appropriate for the user's query. Ideally, the geographic information system is an object-oriented GIS which easily allows the creation of avatars as objects “within” the database. If a more conventional geographic information system is used, then the avatars will have to operate outside the database and run repeat interrogations of the GIS.

In the above embodiment, a GPS position sensing system was used in order to provide the mobile telephone 3 with its current position on the earth's surface. As those skilled in the art will appreciate, various other positioning systems can be used. For example, the Russian-based satellite positioning system called Glonass could be used or the proposed European satellite-based positioning system, Galileo could also be used when it becomes available. Further still, the mobile telephone or the mobile telephone network can identify the current location of the mobile telephone based on the radio signals within the mobile telephone network. This can be achieved, either by monitoring the signals received by the handset from a number of base stations whose locations are known and/or by monitoring the signal from the handset received by a number of base stations of known location. Either the relative signal strengths or the relative timing of synchronised signals may be measured. In such an embodiment, the GPS receiver may be omitted.

In the above embodiment, an electronic compass was provided so that the orientation of the telephone can be determined and hence appropriate instructions can be given to the user to identify an initial direction to travel. If the handset is to be made as simple as possible, then the electronic compass may also be omitted. In this case, the user would have to revert to a more traditional technique of identifying an initial bearing, such as identifying the intersection of two streets.

In the above embodiment, the GPS receiver formed an integral part of the mobile telephone. In an alternative embodiment, the GPS receiver may be provided as a separate unit with an appropriate connection being provided from the GPS receiver to the mobile telephone. Similarly, the electronic compass may also be provided within this or another separate unit.

In the above embodiment, a single navigation control centre was provided. As those skilled in the art will appreciate, several navigation control centres may be provided, each operating within a distinct locality of the geographic region of interest. In this way, each GIS within the control centre may include more detailed geographic data for its designated geographic area. For example, several navigation control centres may be provided in and around large cities whilst one or two may be provided between the cities in more rural areas. In such an embodiment, the control centres would be arranged to communicate with each other so that as a user enters the geographic area of another navigation control centre, a “handover” procedure can be performed. In this way, the navigation control centres form a distributed network of navigation centres.

In the above embodiment, a number of processing units have been described for use in a navigation system. As those skilled in the art will appreciate, these processing units may be dedicated hardware circuits or they may be computer software modules run on a conventional programmable processor. The computer program or programs used to configure such a programmable processor to carry out the processing discussed above may be in the form of source code, object code, a code intermediate source and object code such as a partially compiled form, or in any other form. Such computer programs may be stored in memory at the time of manufacture of the device or it may be loaded into memory by either downloading the program file from, for example, the Internet or from a storage medium such as a CD ROM or the like.

1. A navigation guidance system comprising a user unit and a remote navigation control server;
the user unit comprising:
means for transmitting navigation guidance requests to said remote server;
means for receiving navigation guidance information from said remote server; and
means for outputting the received navigation guidance information to the user;
the remote server comprising:
means for receiving navigation guidance requests from said user unit and location information indicative of a current location of the user unit;
means for determining navigation guidance information in response to a received request and the current location of the user unit; and
means for transmitting the determined navigation guidance information to said user unit;
characterised in that said remote server further comprises:
means for monitoring the location of the user unit after said navigation guidance information has been transmitted to the user unit; and
means for comparing a new current location of the user unit with the navigation guidance information already transmitted to the user unit; in that
said determining means is operable to determine updated navigation guidance information in dependence upon a comparison result output by said comparing means; and in that
said transmitting means of said remote server is operable to transmit said updated navigation guidance information to said user unit.

2. A system according to claim 1, wherein said request for navigation guidance includes a request for directions to a predetermined destination and wherein said determining means of said remote server is operable to determine guidance information to direct the user to the predetermined destination.

3. A system according to claim 2, wherein said determining means of said remote server is operable to determine a plurality of way points between the user's current position and the predetermined destination and is operable to transmit the navigation guidance information in blocks so that said user unit is guided to said destination via each of said determined way points.

4. A system according to claim 3, wherein said transmitting means is operable to transmit navigation guidance information to guide said user unit from its current location to a current way point and wherein said transmitting means is operable to transmit said updated navigation guidance information for guiding the user unit from the current way point to the next way point when the comparing means determines that the user unit is at or near to the current way point.

5. A system according to any preceding claim, wherein said output means comprises a display and wherein said navigation guidance information comprises geographical map data relevant to the user's request, for display on said display.

6. A system according to claim 5, wherein said user unit is operable to transmit details of a map or atlas that the user has and wherein said determining means is operable to determine navigation guidance data including map data corresponding to said map or atlas.

7. A system according to claim 6, wherein said map data includes data identifying a portion of the map or atlas as well as geographic data corresponding to that portion.

8. A system according to claim 7, wherein said geographic data includes a geographic representation of a route to be followed.

9. A system according to claim 8, wherein said geographic data includes an indication of a current position of the user unit on the route to be followed.

10. A system according to claim 9, wherein said telephone is operable to display previous history of positions of the user unit along the route to be followed.

11. A system according to any preceding claim, wherein said outputting means comprises a display and wherein said navigation guidance information comprises text data relevant to the user's request, for display on said display.

12. A system according to any preceding claim, wherein said outputting means comprises a speaker for outputting voice signals, and wherein said navigation guidance information comprises voice signals conveying navigation guidance information relevant to the guidance request.

13. A system according to any preceding claim, wherein said remote server comprises a database including various geographic data and wherein said determining means is operable to filter said database for geographic data relevant to the received navigation guidance request.

14. A system according to claim 13, wherein said database forms part of a geographic information system.

15. A system according to any preceding claim, wherein said remote server is operable to service navigation guidance requests from a plurality of user units.

16. A system according to claim 15, wherein a plurality of said determining means are provided, each for determining navigation guidance information for a respective one of said plurality of users.

17. A system according to claim 16, wherein each determining means comprises an avatar which is operable to filter geographic data stored in the server relevant to the request of the corresponding user.

18. A system according to any preceding claim, wherein said user unit comprises a mobile telephone.

19. A system according to any preceding claim, wherein said user unit comprises position sensing means operable to receive signals from a positioning system and for generating therefrom a position indicating signal indicative of the geographical location of the user unit and wherein said user unit is operable to transmit said position indicating signal to said remote server.

20. A system according to claim 19, wherein said positioning system is a global position system which is located within the user unit.

21. A system according to any preceding claim, wherein said user unit further comprises means for determining the orientation of the user unit, wherein the user unit is operable to transmit this orientation information to the remote server and wherein the remote server is operable to send said navigation guidance information in dependence upon the received orientation information.

22. A system according to any preceding claim, wherein said user unit comprises a communications terminal which is operable to determine its own current location, and wherein said monitoring means is operable to interrogate said communication system to determine said new current location of the user unit.

23. A system according to claim 22, wherein said monitoring means is operable to interrogate said user unit covertly such that the user is unaware of the interrogation.

24. A system according to claim 22 or 23, wherein said determining means is operable to establish a communications channel between the user unit and the remote server in order to download the updated navigation guidance information to the user unit.

25. A method of providing navigation guidance information from a remote server to a user unit, the method comprising the steps of:
at the user unit transmitting a navigation guidance request to the remote server;
at the remote server:
receiving the navigation guidance request from said user unit together with location information indicative of a current location of the user unit;
determining navigation guidance information in response to the received request and the current location of the user; and
transmitting the determined navigation guidance information to the user unit;
at the user unit:
receiving the navigation guidance information transmitted from the remote server; and
outputting the received navigation guidance information to the user;
characterised in that the method further comprises the steps of, at the remote server:
monitoring the location of the user unit after said navigation guidance information has been transmitted to the user unit;
comparing a new current location of the user unit with the navigation guidance information already transmitted to the user unit;
determining updated navigation guidance information in dependence upon a comparison result output by said comparing step; and
transmitting the updated navigation guidance information to the user unit.

26. A user unit comprising:
means for transmitting navigation guidance requests to a remote server;
means for receiving navigation guidance information from the remote server; and
means for outputting the received navigation guidance information to the user.

27. A user unit according to claim 26, further comprising means for determining an orientation of the user unit and wherein said transmitting means is operable to transmit said orientation information to said remote server.

28. A user unit according to claim 26 or 27, wherein said user unit comprises means for receiving signals from an external source and for generating therefrom data representative of a position of the user unit.

29. A user unit according to claim 28, wherein said transmitting means is operable to transmit said position data to said remote server.

30. A user unit according to claim 29, wherein said user unit is a mobile telephone and wherein said transmitting means is operable to transmit said position data without establishing a voice communication link.

31. A user unit according to claim 30, wherein said transmitting means is operable to transmit said position data in response to requests from said remote server.

32. A remote server for use in a navigational guidance system, the remote server comprising:
means for receiving navigation guidance requests from a user unit and location information indicative of a current location of the user unit;
means for determining navigation guidance information in response to a received request and the current location of the user unit; and
means for transmitting the determined navigation guidance information to said user unit;
characterised in that said remote server further comprises:
means for monitoring the location of the user unit after said navigation guidance information has been transmitted to said user unit; and
means for comparing a new current location of the user unit with the navigation guidance information already transmitted to the user unit; in that
said determining means is operable to determine updated navigation guidance information in dependence upon a comparison result output by said comparing means; and in that
said transmitting means is operable to transmit said updated navigation guidance information to said user unit.

33. A remote server according to claim 32, wherein said receiving means is operable to receive orientation information indicative of the current orientation of the user unit and wherein said determining means is operable to determine navigation guidance information based on said orientation information.

34. A computer readable medium storing computer program instructions for configuring a programmable processor as a user unit of any claims 1 to 24 or 26 to 31.

35. A computer readable medium storing computer program instructions for configuring a programmable processor as a remote server of any claims 1 to 25, 32 or 33.

36. Computer program instructions for configuring a programmable processor as a user unit of any claims 1 to 24 or 26 to 31.

37. Computer program instructions for configuring a programmable processor as a remote server of any claims 1 to 25, 32 or 33.
